(19) United States
(12) Patent Application Publication
(10) Pub. No.: US 2006/0104511 A1
(43) Pub. Date: May 18, 2006

(54) Method, system and apparatus for generating structured document files

(76) Inventors: Jinhong Katherine Guo, West Windsor, NJ (US); Yue Ma, West Windsor, NJ (US)

Correspondence Address: RATNERPRESTIA, P O BOX 980, VALLEY FORGE, PA, 19482-0980, US

(21) Appl. No.: 10/524,965

(22) PCT Filed: Aug. 20, 2003
(86) PCT No.: PCT/US03/26025

§ 371 Date: Oct. 14, 2005

Related U.S. Application Data
(60) Provisional application No. 60/404,581, filed on Aug. 20, 2002.

(51) Int. Cl. G06K 9/34

(52) U.S. Cl. 382/176; 382/180

(57) ABSTRACT

A method, system, apparatus, and graphical user interface (GUI) for generating structured document files from a document image is disclosed. Structured document files are generated by segmenting the document image into one or more zones containing respective text images, converting the respective text images to digital text, automatically identifying layout information for each of the one or more zones, labeling each of the one or more zones in accordance with a schema, and automatically associating mark-up language tags with the labeled zones to generate the structured document files responsive to the identified layout information and a model file.

### CROSS REFERENCE TO RELATED APPLICATIONS

This application is related to and claims the benefit of U.S. Provisional Application No. 60/404,581, filed Aug. 20, 2002, for “A System for Generating Structured Document.” In addition, this application is related to U.S. patent application Ser. No. 10/293,859 , filed Nov. 13, 2002, for “Document Classification and Labeling Using Layout Graph Matching.”

### FIELD OF THE INVENTION

The present invention relates to the field of structured languages and, more particularly, to the generation of structured language document files from document images.

### BACKGROUND OF THE INVENTION

Structured languages such as extensible mark-up language (XML) enable the creation of structured document files that are easily searchable and are viewable across multiple platforms, e.g., on a desktop computer and on a cellular telephone. For example, a structured document file retrieved via a global Information network (e.g., the Internet) can be viewed in full on a desktop computer and can be viewed as text only on a cellular telephone. It is often desirable to convert existing hard copy documents or images of documents to structured document files to facilitate searching and displaying these documents. Accordingly, methods, systems, and apparatus for converting documents to structured document files are useful.

Existing documents are typically converted to structured document files by scanning the documents and automatically converting the text within the scanned documents to digital text using optical character recognition (OCR) software. The scanned and converted documents are then formatted, either manually or using proprietary data structures, to add mark-up language tags. Often, several different software packages are employed to perform each of these steps. These methods for generating structured document files tend to be inflexible, time consuming, and/or difficult to use. In addition, the original formatting of the document is often lost, e.g., font sizes, emphasis, etc., making them more difficult to read when they are displayed.

Accordingly, methods, systems, and apparatus for converting existing documents to structured document files are needed that are not subject to the above limitations. The present invention fulfills this need among others.

### SUMMARY OF THE INVENTION

The present invention is a method, system, and apparatus for generating structured document files from document images. Structured document files are generated by segmenting the document image into one or more zones containing respective text images, converting the respective text images to digital text, automatically identifying layout information for each of the one or more zones, labeling each of the one or more zones in accordance with a schema, and automatically associating mark-up language tags with the labeled zones to generate the structured document files responsive to the identified layout information and a model file.

### BRIEF DESCRIPTION OF THE DRAWINGS

FIG. 1 is a block diagram that conceptually represents an exemplary system architecture for generating structured document files from document images in accordance with the present invention;

FIG. 2 is a flow chart of exemplary steps for generating structured document files from document images in accordance with the present invention;

FIG. 3 is an exemplary graphical user interface (GUI) for assisting a user in generating structured document files in accordance with the present invention; and

FIG. 4 is an exemplary document from which structured document files are generated in accordance with the present invention.

### DETAILED DESCRIPTION OF THE INVENTION

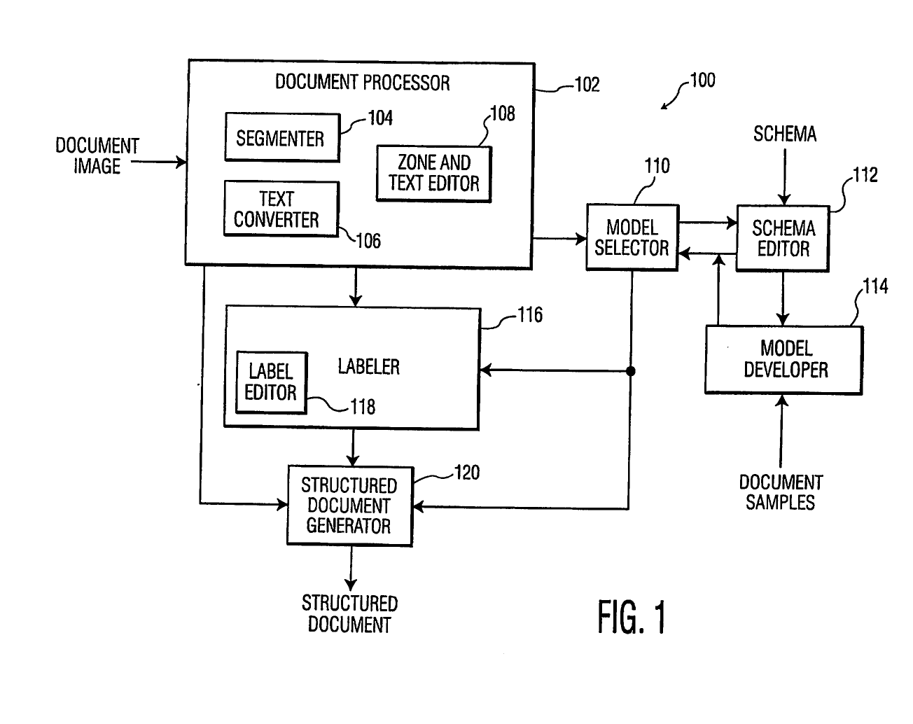

FIG. 1 is a conceptual representation of an exemplary system architecture 100 for generating structured document files from document images in accordance with the present invention. One or more blocks within the illustrated system architecture 100 can be performed by the same piece of hardware or module of software. It should be understood that embodiments of the present invention may be implemented in hardware, software, or a combination thereof. In such embodiments, the various component and steps described below would be implemented in hardware and/or software.

In the illustrated system architecture 100, an electronic image of a document (the “document image”) is applied to a document processor 102. In certain exemplary embodiments, the document image is generated by scanning a physical document using conventional scanning techniques. In certain other exemplary embodiment, the document image is supplied in an electronic format such as a Tagged Image File Format (tiff) file, Joint Photographic Experts Group (jpeg) file, or other such file. In these embodiments, a format converter (not shown) may be used to convert the document image into a format compatible with the present invention. Suitable document images and format converters for use with the present invention will be readily apparent to those of skill in the related arts.

The document processor 102 processes the document image in preparation for labeling and generating the structured document file(s), which actions are described in greater detail below. The illustrated document processor 102 includes a segmenter 104, a text converter 106, and a zone and text editor 108. The segmenter 104 segments the document image into zones containing text or images. For example, the segmenter 104 may create a zone containing the title of a document, a zone containing a paragraph within the document, and a zone containing a figure. In addition, the segmenter 104 determines layout information for the zones. For example, the font size and the position of the zone on the document. A suitable segmenter for use with the present invention will be readily apparent to those of skill in the art of Image processing. Additional information regarding segmenters can be found in commonly assigned U.S. Pat. Nos. 5,892,843 and 6,327,388 to Zhou et al. entitled “Title, Caption and Photo Extraction from Scanned Document Images” and “Identification of Logos from Document Images,” respectively.

In an exemplary embodiment, the segmenter 104 identifies which zones contain text images and which zones contain figures. In certain exemplary embodiments, each zone is displayed in a color that represents the type of information within that zone. For example, text image may be displayed in one color, e.g., red, and non-text images such as tables and figures may be displayed in another color, e.g., green. In certain other exemplary embodiments, the zones may be distinguished in other ways such as with a border having a different color or pattern.

The text converter 106 converts the text images of the zones to digital text, i.e., text which is searchable and editable. For example, the text converter may convert the letters with the text images to their ASCII equivalent. In a exemplary embodiment, the text converter is a conventional optical character recognition (OCR) software tool. Suitable text converters for use with the present invention will be readily apparent to those of skill in the art of image processing.

The zone and text editor 108 edits the zones and the digital text. In an exemplary embodiment, the zone and text editor 108 may add zones, delete zones, or change the size of individual zones responsive to user inputs. For example, a user may enlarge a zone containing a portion of a document title to include the entire title. In an exemplary embodiment, layout information associated with a zone is updated in accordance with the changes to the zones. The zone and text editor 108 also may change the digital text responsive to user inputs. For example, misspelled words may be corrected by a user. In an exemplary embodiment, the zone and text editor 108 receives user inputs via a graphical user interface, which is described in detail /below. Suitable zone and text editors for use with the present invention will be readily apparent to those of skill in the art of image processing.

The document, as processed by the document processor 102, is applied to a model selector 110. The model selector 110 selects a previously developed model file, described below, having features that resemble features of the document. In an exemplary embodiment, the model selector selects the model file from a plurality of previously developed model files. Each of the model files references a schema, which describes the structure of a document that contains valid semantics (e.g. title, author, abstract etc. for a document such as a technical paper) and includes physical characteristics for the elements of the schema and their spatial relationships relative to one another.

In an exemplary embodiment, the model file is selected by a user, e.g., via the graphical user interface (GUI) described below. In an alternative exemplary embodiment, the model selector 110 compares features of the processed document image to stored features of previously developed model files to automatically select a model file. In certain exemplary embodiments, a costing technique is employed with a cost assigned to each feature and lower costs representing a higher level of resemblance. In accordance with this embodiment, a comparison cost is determined for each available model file compared to the document image and the model file with the lowest cost is selected. A method for automatically selecting a model file by matching features is described in commonly assigned U.S. patent application Ser. No. 10/293,859, filed Nov. 13, 2002, for “Document Classification and Labeling Using Layout Graph Matching having at least one common Inventor (referred to herein as the “Document Classification and Labeling Application”).

A schema editor 112 edits the schema. In an exemplary embodiment, the schema is retrieved based on a reference to the schema in the model file. In an alternative exemplary embodiment, the schema may be referenced by a user, e.g., via the GUI described below. The schema editor 112 may be used to add or remove elements from the schema responsive to user inputs. In an exemplary embodiment, the schema editor 112 is displayed in a tree-view and the user inputs are received via the GUI described below. A suitable schema editor will be readily apparent to those of skill in the related arts.

A model developer 114 develops the models for use by the model selector 110. In an exemplary embodiment, the model developer 114 develops the model by processing document samples. In certain exemplary embodiment, the model developer 114 develops the model responsive to user inputs. If the schema is changed by the schema editor 112, the model developer 114 needs to develop a new model in accordance with the new schema that accommodates the new relations. A suitable model developer for use with the present invention is described in the Document Classification and Labeling Application.

In an exemplary embodiment, models are developed at a system level. When developed at the system level, a user's edit and correction activities of logical labeling results are monitored. An automatic model learning process updates the document model through a feedback loop based on user modified results. In an alternative exemplary embodiment, models are developed at the user level. When developed at the user level, a GUI tool is provided to allow a more knowledgeable user to manually create a new model from a set of known samples.

The document, as processed by the document processor 102, Is also applied to a labeler 116. The labeler 116 applies labels to the zones defined by the document processor 102 in accordance with the schema. For example, the labeler may label a zone containing the title of the document with the element “title.” In an exemplary embodiment, the labeler applies labels to the zones responsive to a document model selected by the model selector 110.

In an exemplary embodiment, the labeler 116 automatically labels the zones using a layout graph technique. An exemplary layout graph represents each schema element associated with a selected model file and its spatial relationships to one or more of the other schema elements and another exemplary layout graph represents each zone in a document image and its spatial relationship to one or more of the other zones. In the exemplary embodiment, a document image is compared to a selected model by the layout graphs using a known global scale over total cost matching technique. Because some elements in a document may correspond to multiple zones, multiple zones may match the same element. A suitable layout graph technique for use with the present invention, from which one skilled in the art can develop a suitable labeler 116, is described in the Document Classification and Labeling Application.

A label editor 118 enables manual editing of the labeled zones. In an exemplary embodiment, the label editor 118 updates the labels on zones applied automatically by the labeler 116 responsive to user inputs. For example, if the labeler 116 labeled a zone containing the title of the document with the element “author,” the label editor can be used to change the label of that zone to the correct element, i.e., “title.” In an alternative exemplary embodiment, the label editor 118 labels each of the zones manually responsive to user inputs. In an exemplary embodiment, the label editor 118 receives user inputs via the GUI described below. A suitable label editor 118 for use with the present invention will be readily apparent to those of skill in the art of image processing.

A structured document generator 120 generates structured document files responsive to layout information associated with the zones, labeling results, and the selected model file. In an exemplary embodiment, the structured document generator 120 generates an extensible mark-up language (XML) file and a extensible style-sheet language (XSL) file for each document image that it processes. The XML file represents the document structure and the XSL file represents the document layout. In an exemplary embodiment, the XSL file may represent layout information such as font type and size, font color, and zone coordinates.

To develop the XML file, the exemplary structured document generator 120 receives layout information from the document processor 102 and labeling results from the labeler 116. In an exemplary embodiment, the layout information contains the number of zones within the document, identification numbers for each zone, and the location of each zone. In addition, the structured document generator 120 receives digital text for each zone containing a text image from the document processor 102. In certain exemplary embodiments, the document processor 102 develops a layout file that includes the layout information and the digital text. In these embodiments, the document processor 102 passes the layout file to the structured document generator 120 for processing. In certain other exemplary embodiments, the digital text is included within the labeling results.

The exemplary structured document generator 120 uses the labeling results to match each zone to the appropriate schema elements. The structured document generator 120 then combines the layout file and the labeling results in a manner that will be readily apparent to those skilled in the art of computer programming to generate the XML file. A portion of an exemplary XML file is depicted in Table 6 below.

In certain exemplary embodiments for generating the XML file, the structured document generator 120 also receives the model file, which contains the schema, from the model selector 110. The document generator 120 may then validate the labeling results by comparing the labeling results to the schema to verify that each label of the labeling results corresponds to a schema element. In addition, the structured document generator 120 may use the model file to incorporate a complete document tree structure into the XML file. For example, the element “name” may contain two sub-elements, e.g., first name and last name. In this embodiment, the structure for the sub-elements may be included in the XML file. The incorporation of the document tree structure into the XML file will be readily apparent to those of skill in the art of computer programming. Also, the structured document generator 120 may use the model file to match individual elements to corresponding layout information in the layout file, e.g., using zone coordinates contained in the layout file and in the model file.

To develop the XSL file, the exemplary structured document generator 120 receives the layout information from the document processor 102, the labeling results from the labeler 116, and the model file from the model selector 110. Pseudo code to direct element processing to generate the XSL file is depicted in Table 1.

TABLE 1

Start root of tree
Repeat nodes

If leaf node; no child node

if this node matches multiple zones

output xsl template using <xsl:for-each>

else

output xsl template using <xsl:template match>

get next node

Else; has child node

get child node

Endif

The pseudo code depicted in Table 1 illustrates the processing of the elements by the structured document generator 120. In a tree view representation of the schema, each element of the schema is represented as a node. Each node can have one or more child nodes. For example, a logical element “author” can have two child nodes, e.g., “last name” and “first name”, and it can have multiple instances to reflect multiple authors. A node can also be a leaf node, which indicates there is no branches from this node, such as “first name” or “last name.” Processing continues until all elements/nodes are processed.

For each element processed by the structured document generator 120, the structured document generator 120 matches the element to corresponding layout information in the layout file, e.g., using zone coordinates contained in the layout file and in the model file. The structured document generator 120 then combines the element with the corresponding layout information to generate the XSL file in a manner that will readily apparent to those of skill in the art of computer programming.

In certain exemplary embodiments, a layer concept associated with the hyper text mark-up language (HTML) preserves the original layout, e.g., using <DIV></DIV> tags in the XSL file. Each layer enclosed within the <DIV></DIV> tags is independent of every other layer. Thus, a zone in one layer has no effect on the position of a zone in another layer when the zones are displayed on a known web browser (not shown). Accordingly, a zone may be assigned coordinates with respect to a common origin for display on a web browser without affecting the positioning of any other zone. In addition, each zone can have its own style, e.g., font size, type, and color. In an exemplary embodiment, each zone is assigned to a different layer. The original coordinates for each zone are then used to develop display coordinates in a known manner to display the zone on a web browser. Since the original coordinates for the zones are used to position the zones, the zones are referenced to a common origin, and the zones do not affect the position of zones in other layers, the position of the zones when displayed on a web browser will at least partially match the original layout of the original document image when all layers are displayed. Style information such as font size may also be included to increase the resemblance between the displayed document and the original document image. A portion of an exemplary XSL file is depicted in Table 7 below.

In certain exemplary embodiments, one or more of the zones may contain non-text Images (not shown) that are not converted to digital text such as graphs, pictures, etc. In an exemplary embodiment, for each zone containing a non-text image the structured document generator 120 generates an image file from the portion of the original image within a zone. The structured document generator 120 then inserts a link to the image file in the XML file in a manner similar to the insertion of digital text described above to generate the XML file. In addition, the structured document generator 120 generates the XSL file in a similar manner as described above for text images with the exception that style information such as font size is not included.

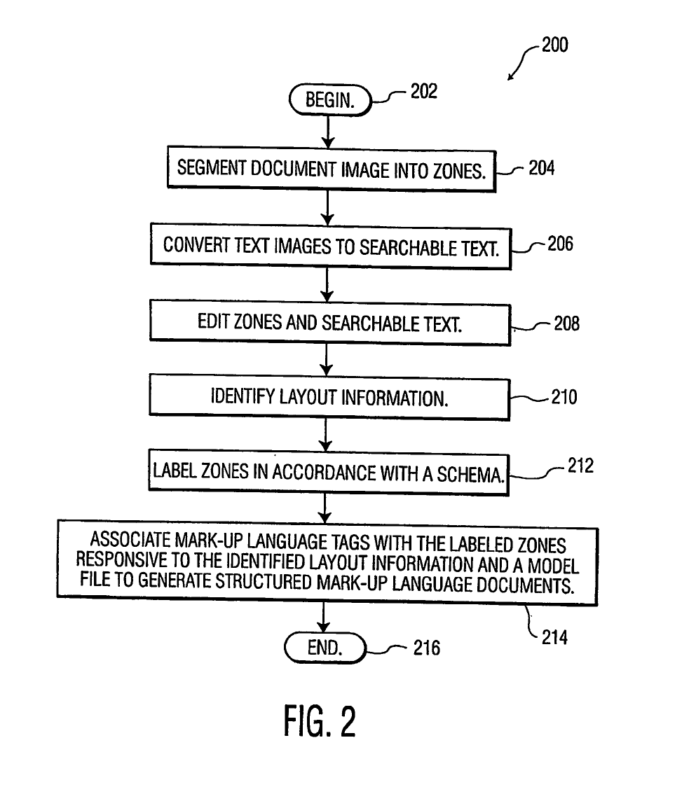

FIG. 2 depicts a flow chart 200 of exemplary steps for generating structured document files in accordance with the present invention. Processing begins at block 202 with the segmentation of the document image into zones at block 204. At block 206, text images within the zones are converted to digital text. At block 208, the zones and digital text are edited. In an exemplary embodiment, the zones are segmented, digital text is converted, and zones and digital text are edited as described above with reference to the segmenter 104, text converter 106, and editor 108, respectively, of FIG. 1.

At block 210, layout information for the document image is identified. The layout information includes non-content related features that define the look of the document. These features may include, by way of non-limiting example, font size, emphasis formatting, positional information, etc. In an exemplary embodiment the layout information is used in the generation of the structured document files such that a displayed image of the structured document files retains at least a portion of the original layout information associated with the document image. Because the original layout information is maintained, the displayed images reflect the formatting of the original documents, thus making them more easy to read. In an exemplary embodiment, the layout information is identified by the above-described segmenter 104 (FIG. 1).

At block 212, the zones are labeled in accordance with a schema and, at block 212, mark-up language tags are associated with to the labeled zones to create the structured document files. In an exemplary embodiment, the zones are labeled and the tags are associated as described above with reference to the labeler 116 and the structured document generator 120, respectively, of FIG. 1.

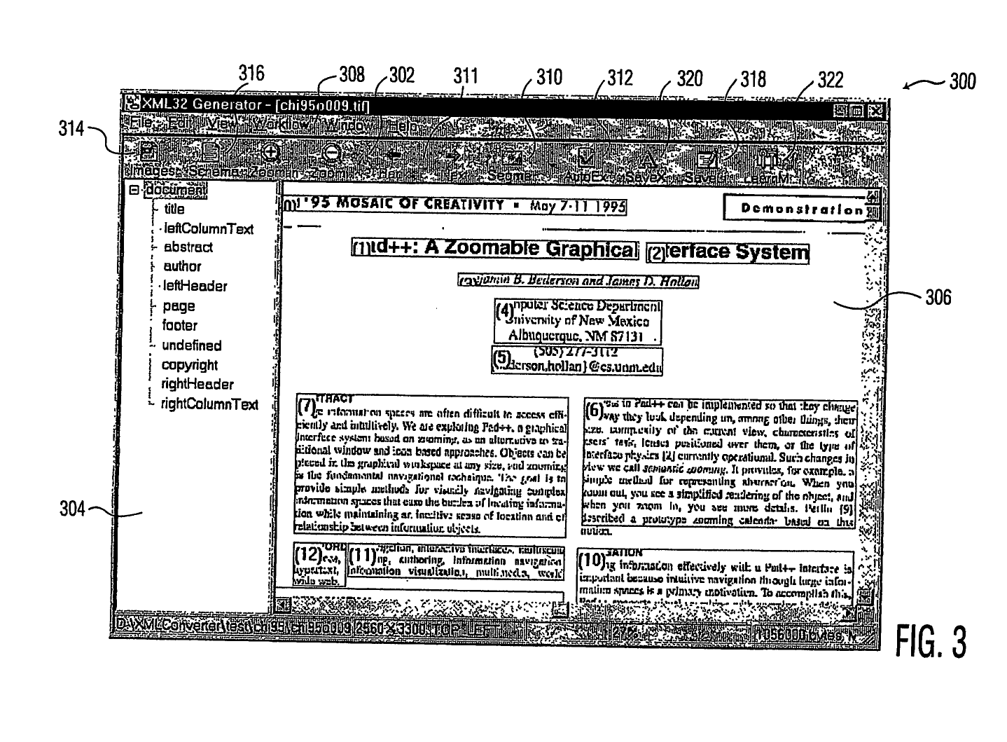

FIG. 3 depicts an exemplary graphical user interface (GUI) 300 for use in the present invention. The illustrated GUI 300 includes a tool bar 302, a schema panel 304, and a viewing panel 306. The GUI 300 provides an easy to user interface that allows a user to generate structured document files from document Images.

In an exemplary embodiment, a user accesses a workflow menu (not shown) by selecting a “workflow” indicator 308 from the tool bar 302. In certain exemplary embodiments, the workflow menu guides the user sequentially through the structured document file generation process described above, e.g., segmenting the document image into zones, converting text to digital text, labeling the zones, and generating the structured document files. In certain other exemplary embodiments, the user is guided through the workflow process by a “workflow” icon 310, which is described in detail below. In certain exemplary embodiments, arrow indicators 311 are available to move back and forth sequentially through the workflow process. Alternatively, the entire workflow process of generating a structured document from a document image is performed automatically by selecting an “auto execute” icon 312 in the toolbar 302.

The “workflow” icon 310 displays unique images that correspond to different steps of the workflow process. In an exemplary embodiment, the “workflow” icon 310 reflects a next step in the workflow process to guide a user sequentially through the process of generating structured document files from document images. For example, prior to loading a document Image, the “workflow” icon 310 may display the text “Load Image,” and after the document image is loaded, but before the document image is segmented, the “workflow” icon 310 may display the text “Segment.” Selecting the workflow icon 310 when the text “Load Image” is displayed results in the loading of an image and selecting the “workflow” icon 310 when the text “Segment” is displayed results in the segmentation of the document image.

In an exemplary embodiment, selecting an “images” icon 314 on the toolbar 302 initiates a document image source selection, e.g., via a conventional file open window (not shown). A selected document image is then displayed in the viewing panel 306.

In an exemplary embodiment, the selection of a document image initiates a model file matching routine that identifies a model file for the document image. From the Identified model file, a schema is identified for display in the schema panel 304, e.g., in a tree view. Alternatively, a user selects the schema manually by selecting a “schema” icon 316 on the toolbar 302. In certain exemplary embodiments, the user changes the automatically or manually selected schema by selecting the “schema” icon 316. In certain exemplary embodiment, the schema may be updated, e.g., elements may be added or removed from the schema, or a new schema may be created using conventional editing techniques. Once editing is complete, the user saves the newly edited (or created) schema file. The model matching process, described above, is performed after a new schema is saved to select a model corresponding to the new schema.

Document segmentation, text conversion, and labeling are performed in the viewing panel 306. In an exemplary embodiment, the document is segmented and text is converted responsive to the loading of a document image. In alternative exemplary embodiments, the document is segmented and the text is converted by selecting the “workflow” icon 310 on the toolbar 302 twice (once to initiate segmentation and once to initiate text conversion) or through the workflow menu (not shown) that appears when the workflow indicator 308 is selected. In accordance with these embodiments, the document is segmented Into “meaningful” zones according to physical attributes such as font size, spacing, etc. In the illustrated embodiment, segmented zones are displayed with bounding boxes overlaid on the original image, which can be corrected by the user using conventional techniques. There are several features that are available within the viewing panel 306. These features include zoom in/out, zone selection/editing, and zone change features. In the Illustrated embodiment, text conversion results for identified text regions are also overlaid directly in each zone for easy review and editing using conventional techniques. It will be readily apparent to those of skill in the art that segmentation and text conversion may be performed concurrently or in two distinct steps.

After segmentation and text conversion, labels are added to the segments. In an exemplary embodiment, labeling is initiated through its selection from the workflow menu or by selecting the “workflow” icon 310. In the illustrated embodiment, the labeling results in the display of logical labels on the top left corner of each zone as shown in FIG. 3. In an exemplary embodiment, the logical labels can be edited in a conventional manner, e.g., by “right-clicking” to display a pull-down menu (not shown) to link and unlink the zone to a schema element or by dragging the schema elements from the scheme tree to a zone. In certain exemplary embodiments, the labels associated with the zones may be saved by selecting a “SaveLink” icon 318 on the tool bar 302.

After labeling, the structured documents are generated by selecting a structured document generation indicator In the workflow menu, selecting the “workflow” Icon 310, or selecting a “Save XML” icon 320 on the toolbar 302. In an exemplary embodiment, this prompts the creation of two structured document files: an XML file and a corresponding XSL file.

The GUI 300 additionally provides an easy to use interface that allows a user to train model files. In an exemplary embodiment, a training mode is entered by selecting this mode from the “workflow” menu or by selecting a “LeamModel” icon 322 on the toolbar 302. In the training mode, a user edits one or more similar sample documents. During editing, the user's edits are monitored and analyzed to develop a model file from the sample documents. The new model file can then be used to segment and label subsequent documents.

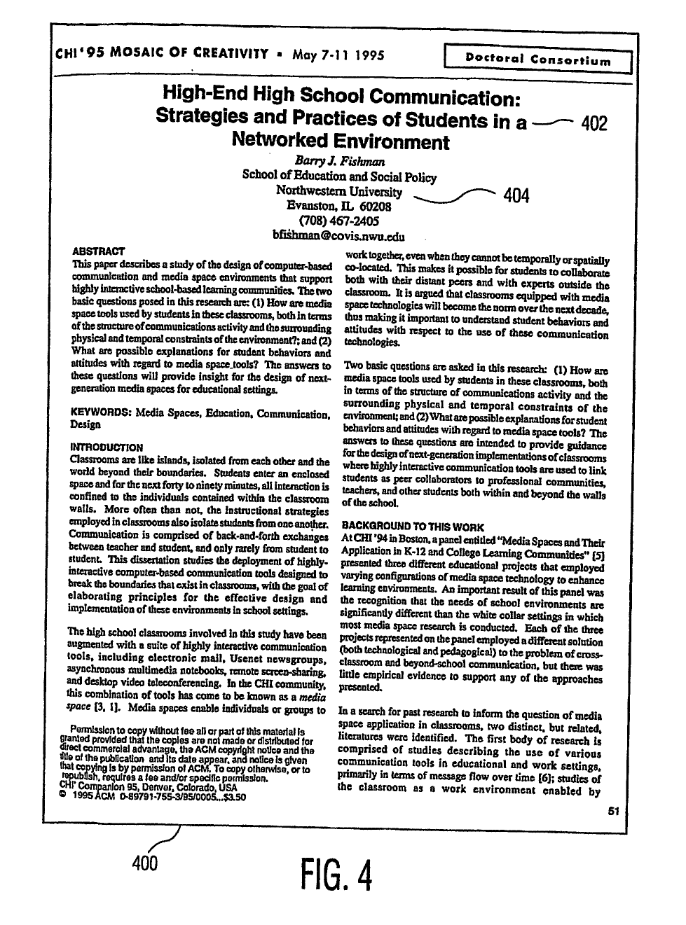

FIG. 4 depicts a document image 400 to be processed in accordance with the present invention. Initially, the document image 400 is scanned using conventional scanning software. The illustrated document image 400 includes several blocks of text including a title 402 and author information 404, e.g., name, telephone number, etc. A schema for a two-column text document similar in style to the document image 400 is included in Table 2.

TABLE 2

<xsd:schema xmlns:xsd=“http://www.w3.org/1999/XMLSchema”>
<xsd:element name=“document”>
<xsd:complexType>
<xsd:element name=“title” type=“xsd:string”/>
<xsd:element name=“leftColumnText” type=“xsd:string”/>
<xsd:element name=“abstract” type=“xsd:string”/>
<xsd:element name=“author” type=“xsd:string”/>
<xsd:element name=“leftHeader” type=“xsd:string”/>
<xsd:element name=“page” type=“xsd:string”/>
<xsd:element name=“footer” type=“xsd:string”/>
<xsd:element name=“undefined” type=“xsd:string”/>
<xsd:element name=“copyright” type=“xsd:string”/>
<xsd:element name=“rightHeader” type=“xsd:string”/>
<xsd:element name=“rightColumnText” type=“xsd:string”/>
</xsd:complexType>
</xsd:element>
</xsd:schema>

The schema includes “elements” that correspond to the blocks of text within the document 400. For example, the element “title” corresponds to the title 402 and the element “author” corresponds to the author information 404.

A portion of the model file associated with the schema of Table 2 is illustrated in Table 3. In an exemplary embodiment, the model file, which references the schema file, i.e., twocolumn.xsd, is trained from a collection of documents. The model file contains the physical characteristics of each element within the schema, their spatial relationships, and the relative weight of the characteristics and spatial relationships.

TABLE 3
<?xml version=“1.0”?>
<!-- Created by jzegmdlWriteXml at 12:22:49 on Friday, 19 April 2002 -->
<jzegGRAPH class=“document” numnode=“10” th=“20” nprob=“0”>

<schemainfo xsi:schemaLocation=“twoColumn.xsd”

xmlns:xsi=“http://www.w3.org/2001/XMLSchema-instance” />

| | | | | | | | | |
|---|---|---|---|---|---|---|---|---|
| <jzegNODE id=“ 0” pos=“ | 238 | 862 | 1249 | 1477 | 743 | 1169 | 1012 | 615” wt=“ |

| | | | | | | | | |
|---|---|---|---|---|---|---|---|---|
| 2 | 1 | 3 | 0 | 3 | 1 | 5 | 0” wnull=“ | 80000” |

label=“abstract”/>

| | | | | | | | | |
|---|---|---|---|---|---|---|---|---|
| <jzegNODE id=“ 1” pos=“ | 673 | 409 | 1920 | 766 | 1296 | 587 | 1247 | 357” wt=“ |

| | | | | | | | | |
|---|---|---|---|---|---|---|---|---|
| 0 | 2 | 0 | 1 | 2 | 1 | 0 | 1” wnull=“ | 80000” |

label=“author”/>

| | | | | | | | | |
|---|---|---|---|---|---|---|---|---|
| <jzegNODE id=“ 2” pos=“ | 198 | 2667 | 1222 | 2971 | 709 | 2819 | 1024 | 304” wt=“ |

| | | | | | | | | |
|---|---|---|---|---|---|---|---|---|
| 3 | 1 | 3 | 1 | 3 | 1 | 10 | 14” wnull=“ | 80000” |

label=“copyright”/>

| | | | | | | | | |
|---|---|---|---|---|---|---|---|---|
| <jzegNODE id=“ 3” pos=“ | 2021 | 2961 | 2361 | 2992 | 2191 | 2976 | 340 | 31” wt=“ |

| | | | | | | | | |
|---|---|---|---|---|---|---|---|---|
| 0 | 0 | 0 | 0 | 0 | 0 | 0 | 0” wnull=“ | 588” |

label=“footer”/>

| | | | | | | | | |
|---|---|---|---|---|---|---|---|---|
| <jzegNODE id=“ 4” pos=“ | 236 | 1529 | 1252 | 2627 | 744 | 2078 | 1016 | 1099” wt=“ |

| | | | | | | | | |
|---|---|---|---|---|---|---|---|---|
| 3 | 0 | 3 | 1 | 3 | 1 | 5 | 0” wnull=“ | 80000” |

label=“leftColumnText”/>

| | | | | | | | | |
|---|---|---|---|---|---|---|---|---|
| <jzegNODE id=“ 5” pos=“ | 160 | 70 | 1460 | 127 | 810 | 99 | 1299 | 57” wt=“ |

| | | | | | | | | |
|---|---|---|---|---|---|---|---|---|
| 2 | 11 | 3 | 9 | 3 | 10 | 13 | 21” wnull=“ | 80000” |

label=“leftHeader”/>

| | | | | | | | | |
|---|---|---|---|---|---|---|---|---|
| <jzegNODE id=“ 6” pos=“ | 2382 | 3097 | 2430 | 3136 | 2406 | 3116 | 49 | 39” wt=“ |

| | | | | | | | | |
|---|---|---|---|---|---|---|---|---|
| 3 | 6 | 3 | 7 | 3 | 7 | 9 | 10” wnull=“ | 80000” |

label=“page”/>

| | | | | | | | | |
|---|---|---|---|---|---|---|---|---|
| <jzegNODE id=“ 7” pos=“ | 1325 | 857 | 2348 | 2953 | 1836 | 1905 | 1022 | 2096” wt=“ |

| | | | | | | | | |
|---|---|---|---|---|---|---|---|---|
| 2 | 1 | 3 | 1 | 3 | 1 | 4 | 1” wnull=“ | 80000” |

label=“rightColumnText”/>

| | | | | | | | | |
|---|---|---|---|---|---|---|---|---|
| <jzegNODE id=“ 8” pos=“ | 1932 | 64 | 2354 | 122 | 2143 | 93 | 422 | 58” wt=“ |

| | | | | | | | | |
|---|---|---|---|---|---|---|---|---|
| 1 | 8 | 2 | 9 | 2 | 9 | 1 | 10” wnull=“ | 80000” |

label=“rightHeader”/>

| | | | | | | | | |
|---|---|---|---|---|---|---|---|---|
| <jzegNODE id=“ 9” pos=“ | 509 | 220 | 2073 | 350 | 1291 | 285 | 1564 | 130” wt=“ |

| | | | | | | | | |
|---|---|---|---|---|---|---|---|---|
| 1 | 8 | 1 | 2 | 3 | 3 | 0 | 2” wnull=“ | 80000” |

label=“title”/>

| | <jzegEDGE id1=“ 0” id2=“ 0” ov=“−1” rel=“ 2 2 2 2 2 1 3 1 3” wt=“ | | | | | | | |
|---|---|---|---|---|---|---|---|---|
| 100 | 100 | 100 | 100 | 100 | 100 | 100 | 100 | 100”/> |
| | <jzegEDGE id1=“ 0” id2=“ 1” ov=“−1” rel=“ 1 3 1 3 1 1 3 3 3” wt=“ | | | | | | | |
| 100 | 100 | 100 | 100 | 100 | 100 | 100 | 100 | 100”/> |
| ... | | | | | | | | |

A portion of an XML layout file resulting from the segmentation of the document image 400 and the conversion of text images to digital text is included in Table 4. In the illustrated embodiment, the results are stored by text lines and segmented into zones. This file contains coordinates of each zone and the coordinates and contents of each line within each zone. (Note: in this example, the font size information is disabled.)

TABLE 4
<PAGE xmlns=“http://www.research.panasonic.com/PINTL/physical”
xsi:schemaLocation=“twoColumn.xsd”
xmlns:xsi=“http://www.w3.org/2001/XMLSchema-instance”>
<ZONE id=“0” box=“183 74 1473 127” zone-type=“TEXT” font-size=“0”>

<LINE id=“0” box=“183 74 1473 127” font-size=“0” ><![CDATA[CHI'95 MOSAIC

OF CREATIVITY - May 7-11 1995 ]]>

</LINE>

</ZONE>
<ZONE id=“1” box=“562 225 2041 466” zone-type=“TEXT” font-size=“0”>

<LINE id=“0” box=“610 225 2012 297” font-size=“0” ><![CDATA[High-End High

School Communication: ]]>

</LINE>
<LINE id=“1” box=“583 315 2041 389” font-size=“0” ><![CDATA[Strategies and

Practices of Students in a ]]>

</LINE>
<LINE id=“2” box=“562 407 1739 466” font-size=“0” ><![CDATA[Networked

EnvIronment ]]>

</LINE>

</ZONE>
<ZONE id=“2” box=“1764 62 2368 133” zone-type=“TEXT” font-size=“0”>

<LINE id=“0” box=“1803 77 2362 116” font-size=“0” ><![CDATA[Doctoral

Consortium ]]>

</LINE>

</ZONE>
<ZONE id=“3” box=“920 488 1690 833” zone-type=“TEXT” font-size=“0”>

<LINE id=“0” box=“1129 499 1482 546” font-size=“0” ><![CDATA[Barry J.

Fishman ]]>

</LINE>
<LINE id=“2” box=“922 559 1691 609” font-size=“0” ><![CDATA[School of

Education and Social Policy ]]>

</LINE>
<LINE id=“3” box=“1058 620 1553 668” font-size=“0” ><![CDATA[Northwestern

University ]]>

</LINE>
<LINE id=“4” box=“1100 681 1508 723” font-size=“0” ><![CDATA[Evanston, IL

60208 ]]>

</LINE>
<LINE id=“5” box=“1150 740 1460 785” font-size=“0” ><![CDATA[( 708 ) 467 -

2405 ]]>

</LINE>
<LINE id=“6” box=“1044 800 1565 833” font-size=“0”

><![CDATA[bfishman@covis.nwu.edu ]]>

</LINE>

</ZONE>
...

An XML label file resulting from the labeling of the zones is included in Table 5. The XML label file references the schema and the layout file. The XML file contains the logical association between elements in the schema (by element name) and zones within a document layout (by zone number, defined in the layout file).

TABLE 5
<?xml version=“1.0”?>
<!-- Created by jzeglogWriteXml at 16:43:10 on Monday, 07 July
2003 -->
<document
layout=“C:\XMLConverter\newSeg\test\chi95\chi95o001_layout.xml”
xsi:schemaLocation=“twoColumn.xsd”
xmlns:xsi=“http://www.w3.org/2001/XMLSchema-instance” >

<leftHeader idref=“0”/>
<title idref=“1”/>
<rightHeader idref=“2”/>
<author idref=“3”/>
<abstract idref=“4”/>
<leftColumnText idref=“5”/>
<leftColumnText idref=“6”/>
<leftColumnText idref=“7”/>
<copyright idref=“8”/>
<rightColumnText idref=“9”/>
<rightColumnText idref=“10”/>
<rightColumnText idref=“11”/>
<rightColumnText idref=“12”/>
<page idref=“13”/>

</document>

A portion of a structured document XML file is include in Table 6. The structured document XML file contains only document contents separated by each logical elements. As can be seen, one logical element (e.g., leftColumnText) in the schema) can have multiple instances (zones), identified by irefID (zone ID).

TABLE 6
<?xml version=“1.0”?>
<?xml-stylesheet type=“text/xsl” href=“chi95o001.xsl”?>
<document xmlns:xsi=“http://www.w3.org/1999/XMLSchema-instance”
xsi:noNamespaceSchemaLocation=“twoColumn.xsd”>
<title idref=“1”><![CDATA[High-End High School Communication:
Strategies and Practices of Students In a
Networked EnvIronment]]></title>
<leftColumnText idref=“5”><![CDATA[KEYWORDS: Media Spaces,
Education,
Communication,
Design]]></leftColumnText>
<leftColumnText idref=“6”><![CDATA[INTRODUCTION
Classroom are like islands, isolated hom each other and the
world beyond their boundaries. Students enter an enclosed
Space and for the next forty to ninety minutes, all interaction is
confined to the individuals contained within the classroom
walls. More often than not, the instructions strategies
employed in classrooms also isolate students from one another.
Communication is comprised of back-and-brth exchanges
between teacher and student, and only rarely from student to
Student. This dissertation studies the deployment of highly
interactive computer-based communication tools designed to
break the boundaries that exist in classrooms, with the goal of
elaborating principles for the effective design and
implementation of these environments in school settings.
]]></leftColumnText>
<leftColumnText idref=“7”><![CDATA[The high school classrooms
involved in
this study have been
augmented with a suite of highly interactive communication
tools, including electronic mail, Usenet newsgroups,
asynchronous multimedia notebooks, remote screen-sharing,
and desktop video teleconferencing. In the CHI community,
this combination of tools has come to be known as a media
space [3,1]. Media spaces enable individuals or groups to
]]></leftColumnText>
<abstract idref=“4”><![CDATA[ABSTRACT
This paper describes a study of the design of computer-based
communication and media space environments that support
highly interactive school-based learning communities. The two
basic questions posed in this research are: (1) How are media
space tools used by students in these classrooms, both in terms
of the structure of communications axctivity and the surrounding
physical and temporal constrains of the environment?; and (2)
What are possible explanations for student behaviors and
attitudes with regard to media space tools? The answers to
these questions will provide insight for the design of next-
generation media spaces for educational settings.
]]></abstract>
<author idref=“3”><![CDATA[Barry J. Fishman
School of Education and Social Policy
Northwestern University
Evanston, IL 60208
( 708 ) 467 -2405
bfishman@covis.nwu.edu]]>
</author>
...

A portion of a structured document XSL file is included in Table 7. The structured document XSL file describes how each zone in the structured document XML file should be presented (coordinates, font size, etc.). In an exemplary embodiment, this file is automatically generated to reflect the original layout of the document. However, it can be modified to adapt to different display devices. For example, in an XML browser on a PDA, because of the limited display size, the font may be set to a smaller size and/or only the “abstract” element may be displayed.

TABLE 7
<?xml version=“1.0” encoding=“gb2312”?>
<xsl:stylesheet xmlns:xsl=“http://www.w3.org/1999/XSL/Transform”
version=“1.0”>
<xsl:template match = “/”>
<html><body>
<xsl:for-each select =“/document/title”>
<div id=“layer1” style=“position:absolute; width:1499px; height:261px; z-
index:1; left: 552px; top: 215px”>
<Font style=“font-size:25pt;color:#000000”>
<xsl:value-of select =“text( )”/>
</Font></div>
</xsl:for-each>
<xsl:for-each select =“/document/leftColumnText”>
<xsl:if test=“@idref[.=‘5’]”>
<div id=“layer2” style=“position:absolute; width:1034px; height:116px; z-
index:2; left: 247px; top: 1512px”>
<Font style=“font-size:25pt;color:#000000”>
<xsl:value-of select =“text( )”/>
</Font></div>
</xsl:if>
<xsl:if test=“@idref[.=‘6’]”>
<div id=“layer2” style=“position:absolute; width:1057px; height:708px; z-
index:2; left: 236px; top: 1660px”>
<Font style=“font-size:25pt;color:#000000”>
<xsl:value-of select =“text( )”/>
</Font></div>
</xsl:if>
<xsl:if test=“@idref[.=‘7’]”>
<div id=“layer2” style=“position:absolute; width:1045px; height:364px; z-
index:2; left: 236px; top: 2404px”>
<Font style=“font-size:25pt;color:#000000”>
<xsl:value-of select =“text( )”/>
</Font></div>
</xsl:if>
</xsl:for-each>
<xsl:for-each select =“/document/abstract”>
<div id=“layer3” style=“position:absolute; width:1044px; height:611px; z-
index:3; left: 244px; top: 871px”>
<Font style=“font-size:25pt;color:#000000”>
<xsl:value-of select =“text( )”/>
</Font></div>
</xsl:for-each>
<xsl:for-each select =“/document/author”>
<div id=“layer4” style=“position:absolute; width:790px; height:364px; z-
index:4; left: 910px; top: 478px”>
<Font style=“font-size:25pt;color:#000000”>
<xsl:value-of select =“text( )”/>
</Font></div>
</xsl:for-each>
...

Although the invention has been described in terms of a document processor 102, labeler 116, and structured document generator 120, it is contemplated that the invention may be implemented in software on a general purpose computer (not shown). In this embodiment, one or more of the functions of the various components may be implemented in software that controls the general purpose computer. This software may be embodied in a computer readable carrier, for example, a magnetic or optical disk, a memory-card or an audio frequency, radio-frequency, or optical carrier wave.

Although the invention is illustrated and described herein with reference to specific embodiments, the invention is not intended to be limited to the details shown. Rather, various modifications may be made in the details within the scope and range of equivalents of the claims and without departing from the invention.

What is Claimed:

1. A method for generating structured document files from a document image, the method comprising the steps of:
segmenting the document image into one or more zones, at least one of the one or more zones containing a respective text image;
converting the respective text images within the at least one of the one or more zones to digital text;
automatically identifying layout information for each of the one or more zones;
labeling each of the one or more zones in accordance with a schema; and
automatically associating mark-up language tags with the labeled zones to generate the structured document files responsive to the identified layout information and a model file.

2. The method of claim 1, wherein the model file is associated with the schema and wherein the labeling step comprises at least the steps of:
automatically labeling each of the one or more zones responsive to the model file.

3. The method of claim 1, further comprising the steps of:
receiving editing commands corresponding to the one or more zones; and
updating the one or more zones responsive to the editing commands.

4. The method of claim 3, wherein the step of receiving editing commands includes the step of receiving text editing commands and the step of updating the one or more zones includes the step of editing the digital text responsive to the text editing commands.

5. The method of claim 3, wherein the step of receiving editing commands includes the step of receiving segmenting commands and the step of updating the one or more zones includes the step of updating characteristics of the one or more zones responsive to the segmenting commands.

6. The method of claim 1, further comprising the step of:
receiving editing commands corresponding to the schema;
updating the schema responsive to the editing commands.

7. The method of claim 1, wherein the respective text images are displayed on a graphical user interface (GUI) and wherein the converting step comprises at least the step of:
overlaying the respective text images displayed on the GUI with the at least one of the one or more zones with the corresponding digital text.

8. The method of claim 1, wherein the structured document files include an XML file and an XSL file for each document image and wherein the generating steps comprises at least the step of:
formating the XSL file such that information corresponding to each of the labeled zones in the XML file is displayed in multiple layers on a web browser.

9. The method of claim 1, wherein the steps of segmenting, converting, labeling, and automatically associating mark-up language tags are performed sequentially responsive to a selection of a workflow icon of a graphical user interface and wherein the method further comprises the step of:
updating the workflow icon to represent a next step of the segmenting, converting, labeling, and automatically associating mark-up language tags to be performed, wherein the workflow icon presents a unique image corresponding to each step.

10. A system for generating structured document files from a document image, the system comprising:
means for segmenting the document image into one or more zones, at least one of the one or more zones containing a respective text image;
means for converting the respective text images within the at least one of the one or more zones to digital text;
means for automatically identifying layout information for each of the one or more zones;
means for labeling each of the one or more zones in accordance with a schema; and
means for automatically associating mark-up language tags with the labeled zones to generate the structured document files responsive to the identified layout Information and a model file.

11. The system of claim 10, further comprising:
means for receiving editing commands corresponding to the one or more zones; and
means for updating the one or more zones responsive to the editing commands.

12. The system of claim 10, further comprising:
means for receiving editing commands corresponding to the schema;
means for updating the schema responsive to the editing commands.

13. A structured mark-up language generator for generating structured document files from a document image, the generator comprising:
a document processor that: a) segments the document image into one or more zones, at least one of the one or more zones containing a respective text image, b) s identifies layout information for each of the one or more zones, and c) converts the respective text images within the at least one of the one or more zones to digital text;
a labeler that labels each of the one or more zones in accordance with a schema; and
a structured document generator that generates the structured document files responsive to the identified layout information and a model file.

14. The generator of claim 13, further comprising:
an editor coupled to the document processor that enables editing of the digital text and the one or more zones.

15. The generator of claim 13, further comprising:
an editor coupled to the labeler that enables editing of the labels for each of the one or more zones.

16. A graphical user interface (GUI) for generating structured document files from a document image, the GUI comprising:
a document panel for displaying a document image;
a schema panel for displaying a schema corresponding to the document image; and
a workflow icon for directing the generation of at least one structured mark-up language document from the document image, the workflow icon reflecting a next step in a process to generate the at least one structured mark-up language document.

17. The GUI of claim 16, wherein the process includes sequentially performing the steps of loading an image, segmenting the image into zones, converting text within the zones to digital text, labeling the zones, and generating the at least one structured document and wherein the workflow icon is updated during the process to s present unique images corresponding to each step to be performed in the process.

18. A computer readable medium including software that is configured to control a general purpose computer to implement a method for generating structured document files from a document image, the method comprising the steps of:
segmenting the document image into one or more zones, at least one of the one or more zones containing a respective text image;
converting the respective text images within the at least one of the one or more zones to digital text;
automatically identifying layout information for each of the one or more zones;
labeling each of the one or more zones in accordance with a schema; and
automatically associating mark-up language tags with the labeled zones to generate the structured document files responsive to the identified layout information and a model file.

19. The computer readable medium of claim 18, wherein the method implemented by the software configured general purpose computer further comprises:
updating the one or more zones responsive to editing commands corresponding to the one or more zones.

20. The computer readable medium of claim 18, wherein the method implemented by the software configured general purpose computer further comprises:
updating the schema responsive to editing commands corresponding to the schema.
